(19) United States
(12) Patent Application Publication
(10) Pub. No.: US 2024/0242238 A1
(43) Pub. Date: Jul. 18, 2024

(54) COMPUTER-IMPLEMENTED METHOD FOR ESTIMATING A CONSUMPTION OF AN AGRICULTURAL PRODUCT FOR A GEOGRAPHICAL REGION

(71) Applicant: BASF SE, Ludwigshafen (DE)

(72) Inventors: Christoph LOEFFEL, Limburgerhof (DE); Tobias HAUSEN, Limburgerhof (DE); Benjamin PRIESE, Ludwigshafen (DE); Venkata Ramana PERI, Limburgerhof (DE); Thomas CHRISTEN, Limburgerhof (DE); Michael MERK, Limburgerhof (DE)

(21) Appl. No.: 18/561,876

(22) PCT Filed: May 20, 2022
(86) PCT No.: PCT/EP2022/063690

§ 371 Date: Nov. 17, 2023

(30) Foreign Application Priority Data
May 21, 2021 (EP) 21175285.2

(51) Int. Cl. G06Q 30/0204; G06Q 50/02

(52) U.S. Cl. CPC G06Q 30/0205; G06Q 50/02

(57) ABSTRACT

A computer-implemented method (100) for estimating a consumption of an agricultural product for an area of a geographical region cultivated with a specific crop, the method comprising the steps: providing (110) crop growth index data for the geographical region; determining (120) an area of the geographical region cultivated with a specific crop at least based on a comparison of the provided crop growth index data with plant-specific reference data; providing (130) a product consumption model for the agricultural product configured to estimate a consumption of the agricultural product at least based on the area of the geographical region cultivated with the specific crop; providing (140) an estimation of the consumption of the agricultural product for the determined area of the geographical region cultivated with the specific crop for the geographical region at least based on the determined area cultivated with the specific crop using the product consumption model.

### TECHNICAL FIELD

The present disclosure relates to a computer-implemented method for estimating a consumption of an agricultural product for an area of a geographical region cultivated with a specific crop, a computer-implemented method for providing training data for a machine learning algorithm for estimating a consumption of an agricultural product for an area of a geographical region cultivated with a specific crop, a neural network/machine learning model for estimating a consumption of an agricultural product for an area of a geographical region cultivated with a specific crop, an apparatus for estimating a consumption of an agricultural product for an area of a geographical region cultivated with a specific crop and to a corresponding computer program element.

### TECHNICAL BACKGROUND

In agriculture, many agricultural products (e.g. seeds, pesticides, fertilizers, etc.) have to be applied or delivered to an agricultural field by the farmer at a specific time or time frame and it is thus very important that the required agricultural products can be delivered to the farmer at these defined times. However, the production and transportation of many of these agricultural products requires a certain lead time before they can be delivered to a farmer. For this reason, in the production of agricultural products, purchasing, storage and other logistical sub-areas of agriculture, the manufacturers, suppliers and subcontractors have to estimate the necessary quantities of the agricultural products required by the agriculture for a certain period of time in order to be able to reliably provide the corresponding quantities of the required agricultural products. Until now, the required quantities of agricultural products have often been estimated on the basis of manufacturers' many years of experience. However, in practice this also has led to deviations between the estimated quantity and the quantity actually required, which is of considerable disadvantage in the case of overproduction with agricultural products that cannot be stored easily and/or agricultural products that can only be stored at high cost. In addition, supply bottlenecks may occur, if the estimate was too low.

Thus, it has been found that a further need exists to provide means to estimate a consumption of an agricultural product for a geographical region.

Thus, it is an object of the present invention to provide means, e.g. methods, systems, etc., to estimate a consumption of an agricultural product for a geographical region. These and other objects, which become apparent upon reading the following description, are solved by the subject matter of the independent claims. The dependent claims refer to preferred embodiments of the invention.

### SUMMARY OF THE INVENTION

A first aspect of the present disclosure relates to a computer-implemented method for estimating a consumption of an agricultural product for an area of a geographical region cultivated with a specific crop, the method comprising the steps:
providing crop growth index data for the geographical region;
determining an area of the geographical region cultivated with a specific crop at least based on a comparison of the provided crop growth index data with plant-specific reference data;
providing a product consumption model for the agricultural product configured to estimate a consumption of the agricultural product at least based on the area of the geographical region cultivated with the specific crop;
providing an estimation of the consumption of the agricultural product for the determined area of the geographical region cultivated with the specific crop for the geographical region at least based on the determined area cultivated with the specific crop using the product consumption model.

A further aspect of the present disclosure relates to a computer-implemented method for providing training data for a machine learning algorithm for estimating a consumption of an agricultural product for an area of a geographical region cultivated with a specific crop, the method comprising the steps:
providing data comprising information about an area cultivated with a specific crop;
providing consumption data of the agricultural product for the provided area cultivated with the specific crop;
labeling the data comprising information about the area cultivated with the specific crop with the consumption data of the agricultural product for the provided area cultivated with the specific crop.

A further aspect of the present disclosure relates to a neural network/machine learning model for estimating a consumption of an agricultural product for an area of a geographical region cultivated with a specific crop trained with training data according to the above-mentioned computer-implemented method for providing training data for a machine learning algorithm estimating a consumption of an agricultural product for an area of a geographical region cultivated with a specific crop.

A further aspect of the present disclosure relates to an apparatus for estimating a consumption of an agricultural product for an area of a geographical region cultivated with a specific crop, the apparatus comprising:

one or more computing nodes and one or more computer-readable media having thereon computer-executable instructions that are structured such that, when executed by the one or more computing nodes, cause the apparatus to perform the following steps:
providing crop growth index data for the geographical region;
determining an area of the geographical region cultivated with a specific crop at least based on a comparison of the provided crop growth index data with plant-specific reference data;
providing a product consumption model for the agricultural product configured to estimate a consumption of the agricultural product at least based on the area of the geographical region cultivated with the specific crop;
providing an estimation of the consumption of the agricultural product for the determined area of the geographical region cultivated with the specific crop at least based on the determined area cultivated with the specific crop using the product consumption model.

A further aspect of the present disclosure relates to a system for estimating a consumption of an agricultural product for an area of a geographical region cultivated with a specific crop, the system comprising:
a providing unit configured to provide crop growth index data for the geographical region;
a determination unit configured to determine an area of the geographical region cultivated with a specific crop at least based on a comparison of the provided crop growth index data with plant-specific reference data;
a providing unit configured to provide a product consumption model for the agricultural product configured to estimate a consumption of the agricultural product at least based on the area of the geographical region cultivated with the specific crop;
a providing unit configured to provide an estimation of the consumption of the agricultural product for the determined area of the geographical region cultivated with the specific crop at least based on the determined area cultivated with the specific crop using the product consumption model.

In a further aspect of the present disclosure, a computer program element with instructions is disclosed, which, when executed on computing node(s)/devices of a computing environment, is configured to carry out the steps of the method for estimating a consumption of an agricultural product for an area of a geographical region cultivated with a specific crop. In a further aspect of the present disclosure, a computer readable medium having stored such a computer program element is provided.

Any disclosure and embodiments described herein relate to the methods, the system, the apparatus, the computer program element lined out above and vice versa. Advantageously, the benefits provided by any of the embodiments and examples equally apply to all other embodiments and examples and vice versa.

As used herein “determining” also includes “initiating or causing to determine”, “generating” also includes “initiating or causing to generate” and “providing” also includes “initiating or causing to determine, generate, select, send or receive”. “Initiating or causing to perform an action” includes any processing signal that triggers a computing device to perform the respective action.

The present disclosure is, inter alia, based on the finding that by means of a crop growth index, it can be determined which areas of a geographical region are cultivated with which crops. Based on the information about the area, i.e. the size of the area, it is possible to estimate the consumption of an agricultural product for the geographical region. As a result, manufacturing processes, logistics processes and warehouse activities can be planned and executed in a much safer and more predictable manner, significantly reducing the associated costs of planning and occurring forecast errors. Moreover, since agricultural products may also be used until it's expire dates, the present disclosure allows to significantly reduce that agricultural products must be disposed of.

### Definitions

The term agricultural product is to be understood broadly in the present disclosure and comprises any object or material useful/required for the treatment of an agricultural field. In the context of the present disclosure, the term agricultural product includes but is not limited to:
chemical products such as fungicide, herbicide, insecticide, acaricide, molluscicide, nematicide, avicide, piscicide, rodenticide, repellant, bactericide, biocide, safener, plant growth regulator, urease inhibitor, nitrification inhibitor, denitrification inhibitor, or any combination thereof;
biological products such as microorganisms useful as fungicide (biofungicide), herbicide (bioherbicide), insecticide (bioinsecticide), acaricide (bioacaricide), molluscicide (biomolluscicide), nematicide (bionematicide), avicide, piscicide, rodenticide, repellant, bactericide, biocide, safener, plant growth regulator, urease inhibitor, nitrification inhibitor, denitrification inhibitor, or any combination thereof;
fertilizer and nutrient;
seed and seedling;
water;
agricultural equipment/devices, e.g. sprayers, harvesters, machines, and spare parts for such equipment/devices; and/or
any combination thereof.

The term “geographical region” has to be understood broadly in the present disclosure and ranges from an agricultural field of a farmer to entire countries, for example Germany. Preferably, the term geographical region can be understood to mean, for example, a county/district, a region such as southern Bavaria or the like. The geographical region can be chosen in such a way that the product consumption can be estimated for a delivery area of a producer. Particularly preferably, the term geographical region is understood to mean an area of more than 400 square kilometers.

An “area of a geographical region cultivated with a specific crop” means the area of the geographic region that has been planted with the specific crop. In other words, the “area of a geographical region cultivated with a specific crop” is the area that results from adding up the respective sub-areas on which the specific crop is grown in the geographical region. For example, if wheat is grown on 100 individual fields of 2 hectares each, whereby the individual fields can be distributed arbitrarily in the geographical region, then the “area of a geographical region cultivated with a specific crop” is 200 hectares. Based on this area, the consumption of an agricultural product needed for the treatment of the determined area can then be estimated. In an example, the “area” may be expressed in hectares, square meters, square kilometers or similar.

The term “crop growth index data” is to be understood broadly and comprises any crop growth index data allowing to determine at least the type of crop cultivated in the geographical region by comparison with reference data. In an example, the crop growth index data is Normalized Difference Vegetation Index (NDVI) data and the reference data is crop specific NDVI data. The reference data, for example the NDVI data, can be used not only to determine the specific crop by comparison of the data, but also, for example, to determine or compare whether the specific crop is healthy, damaged or diseased. The latter can be compared, specified and quantified particularly well with NDVI data, since crop leaves reflect the light differently according to their condition.

The term “plant-specific reference data” refers to any data which allows to conclude on a specific crop by comparing the provided crop growth index data with the reference data.

In an example, the “plant-specific reference data” may be used to train a machine-learning algorithm which in turn may specify the specific crop cultivated in the geographical region.

The term “biomass data” of a specific crop has to be understood broadly in the present disclosure and refers to any data/index/number/parameter, which directly or indirectly indicates the biomass of the specific crop at a certain point in time t₁ in the geographical region. However, different sources from different points in time may be used to determine the biomass data for the geographical region for the time t₁, as long as they can be calculated/aligned to the time t₁. Biomass data can be derived from remote sensing measurements, e.g. satellite images or multi spectral Information, and the analysis of the spectral reflectance values for an observed geographic area/region. An example, how such biomass data can be derived/calculated for a specific crop, e.g. corn or soybeans, is explained in the paper “Vegetation water content estimation for corn and soybeans using spectral indices derived from MODIS near- and short-wave infrared bands” (Daoyi Chen et al., Remote Sensing of Environment, Volume 98, Issues 2-3, Oct. 15, 2005, Pages 225-236).

The term “specific crop” includes all agronomically usable plants, trees and bushes, etc., e.g. wheat, fruit trees or fruit bushes, etc. Moreover, the term specific crop may also be understood as all crops/plants, which need a treatment with a specific agricultural product, e.g. all crops which need a treatment with a soil herbicide.

The term “crop growth model” has to be understood broadly in the present disclosure and refers to any computer-operable model, method, mathematical algorithm, which can be used to calculate/estimate biomass data for a time t₂ based on the biomass data of the specific crop at a time t₁. An example for such a cop growth model is explained in the paper “Use time series NDVI and EVI to develop dynamic crop growth metrics for yield modeling” (Sadia Alam Shammi, et al., Ecological Indicators, Volume 121, February 2021).

The term “product consumption model” is to be understood broadly in the present disclosure and refers to any computer-operable model, method, mathematical algorithm, which can be used to calculate/estimate a consumption of the agricultural product for a specific point in time or a time period. Such a product consumption may be at least based on the determined area of the geographical region cultivated with a specific crop. However, it is not excluded that further parameters are used in the product consumption model. Also shelf life data of the agricultural products, expected planting decision of the farmers, pest and disease pressure data, regulatory data for the agricultural products and the like can be taken into account here in order to improve the accuracy of the product consumption estimation. The relation between the determined area and the demand for an agricultural product during a season may be derived from historically observed demand patterns as well as empirical experience, e.g. as explained in the “Pflanzenschutzberater-Kloster Mühle” in which the usual use of various agricultural products in the different plant states are explained. In this context, however, a large number of other sources/recommendations are known which can be used here. In addition, a consumption model specialized or trained for this purpose can be used for each agricultural product. For example, a consumption model for herbicides, a consumption model for fertilizers, a consumption model for pesticides, etc., can be used. However, these consumption models can also be combined into a single consumption model. In an example, a consumption model may be provided, by the standard recommended application rates, e.g. for Cantus Gold, a fungicide for the treatment of ripening diseases in oilseed rape a standard application rate of 0.5 l/ha is recommended.

The term machine-learning algorithm has to be understood broadly and preferably comprises decision trees, naive bayes classifications, nearest neighbors, neural networks, convolutional neural networks, generative adversarial networks, support vector machines, linear regression, logistic regression, random forest and/or gradient boosting algorithms. Preferably, the machine-learning algorithm is organized to process an input having a high dimensionality into an output of a much lower dimensionality. Such a machine-learning algorithm is termed “intelligent” because it is capable of being “trained”. The algorithm may be trained using records of training data. A record of training data comprises training input data and corresponding training output data. The training output data of a record of training data is the result that is expected to be produced by the machine-learning algorithm when being given the training input data of the same record of training data as input. The deviation between this expected result and the actual result produced by the algorithm is observed and rated by means of a “loss function”. This loss function is used as a feedback for adjusting the parameters of the internal processing chain of the machine-learning algorithm. For example, the parameters may be adjusted with the optimization goal of minimizing the values of the loss function that result when all training input data is fed into the machine-learning algorithm and the outcome is compared with the corresponding training output data. The result of this training is that given a relatively small number of records of training data as “ground truth”, the machine-learning algorithm is enabled to perform its job well for a number of records of input data that higher by many orders of magnitude.

In an embodiment of the computer-implemented method for estimating a consumption of an agricultural product, the agricultural product is a fungicide, an herbicide, an insecticide, an acaricide, a molluscicide, a nematicide, an avicide, a piscicide, a rodenticide, a repellant, a bactericide, a biocide, a safener, a plant growth regulator, a urease inhibitor, a nitrification inhibitor, a denitrification inhibitor, a fertilizer, a nutrient, a seed/seedling, and/or combination thereof. In an embodiment, the specific crop is wheat, winter oilseed rape, winter roe, sugar beet, winter wheat, etc.

In an embodiment of the computer-implemented method for estimating a consumption of an agricultural product, the crop growth index data is Normalized Difference Vegetation Index (NDVI) data, Leaf Area Index (LAI) data, Normalized Difference Water Index (NDWI) data, Enhanced Vegetation Index (EVI) data.

In an embodiment of the computer-implemented method for estimating a consumption of an agricultural product, cultivated areas in the geographical region are determined for a preselected group of specific crops based on the crop growth index data for the geographical region. In an example, the preselected group of specific crops is the combination of winter oilseed rape, winter roe, sugar beet and winter wheat which are determined in parallel.

In an embodiment of the computer-implemented method for estimating a consumption of an agricultural product, the crop growth index data are provided at an early crop stage of the specific crop, e.g. 21 days after seeding. The determination of the area already in an early planting stage allows correspondingly already a consumption estimation in such an early stage in the season.

In an embodiment of the computer-implemented method for estimating a consumption of an agricultural product, the crop growth index data, preferably the Normalized Difference Vegetation Index (NDVI) data, is provided for a time period between a starting time t₁ which is the current time or a time between 15 and 30 days after the seeding of the specific crop, preferably between 17 and 25 days after seeding the specific crop and most preferably 21 days after seeding the specific crop, and a ending time t₂ which is between 2 and 10 weeks after t₁, preferably between 4 and 8 weeks after t₁ and most preferably 6 weeks after t₁. By taking into account not only a point in time but a time period, the accuracy of the determination of which areas have been planted with which specific crop may be significantly improved. Moreover, the present disclosure allows to provide a continuous monitoring of the geographic region, so that the respective subsequent processes, e.g. manufacturing processes of the agricultural product, may also be continuously adjusted and optimized.

In an embodiment of the computer-implemented method for estimating a consumption of an agricultural product, the crop growth index data are provided for a predetermined time series.

In an embodiment of the computer-implemented method for estimating a consumption of an agricultural product, the plant-specific reference data are provided by a central and/or distributed computing environment.

In an embodiment of the computer-implemented method for estimating a consumption of an agricultural product, determining the area cultivated with the specific crop is based on data obtained by using Synthetic Aperture Radar (SAR), Light Detection and Ranging (LIDAR) via satellites, unmanned vehicles, vehicle mounted sensors and/or a combination thereof.

In an embodiment of the computer-implemented method for estimating a consumption of an agricultural product, the product consumption model for the area cultivated with the specific crop is based on the results of a machine-learning algorithm configured to estimate the consumption of the agricultural product at least based on the area of the geographical region cultivated with the specific crop.

In an embodiment of the computer-implemented method for estimating a consumption of an agricultural product, the method is further comprising at least one of the following steps:
providing stock recommendation data for a minimum stock level of the agricultural product at a specific time and/or for a time period based on the estimation of the consumption of the agricultural product; and/or
providing stock recommendation data for a minimum stock level of base materials necessary for the production of the agricultural product at a specific time and/or for a time period based on the estimation of the consumption of the agricultural product; and/or
providing production recommendation data for producing the agricultural product based on the estimation of the consumption of the agricultural product; and/or
providing order recommendation data for ordering an amount of the agricultural product and/or an amount of base materials necessary for the production of the agricultural product based on the estimation of the consumption of the agricultural product; and/or
providing overview data for agricultural products needed and/or recommended for the specific crop; and/or
providing control data for a manufacturing process, logistics process and/or warehouse process with respect to the agricultural product based on the estimation of the consumption of the agricultural product.

### BRIEF DESCRIPTION OF THE DRAWINGS

In the following, the present disclosure is further described with reference to the enclosed figures:

FIG. 1 is a flow diagram of an example method for estimating a consumption of an agricultural product for a geographical region;

FIG. 2 is a schematic illustration of an example system for estimating a consumption of an agricultural product for a geographical region; and

FIG. 3 is a schematic illustration of NDVI data for a geographical region over a time period; and

FIG. 4 is a schematic illustration of a geographical region in which specific crops are indicated.

### DETAILED DESCRIPTION OF EMBODIMENT

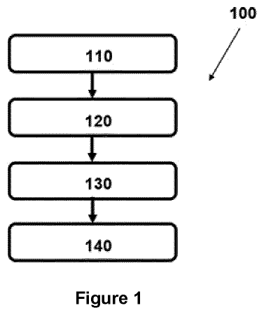

FIG. 1 is a flow diagram of an example method 100 for estimating a consumption of an agricultural product for a geographical region. For example, the agricultural product is a fungicide, an herbicide, an insecticide, an acaricide, a molluscicide, a nematicide, an avicide, a piscicide, a rodenticide, a repellant, a bactericide, a biocide, a safener, a plant growth regulator, a urease inhibitor, a nitrification inhibitor, a denitrification inhibitor, a fertilizer, a nutrient, a seed/seedling, and/or combination thereof.

In a step 110, crop growth index data for a geographical region, e.g. Bavaria, is provided. The crop growth index data may be Normalized Difference Vegetation Index (NDVI) data, Leaf Area Index (LAI) data, Normalized Difference Water Index (NDWI) data, Enhanced Vegetation Index (EVI) data. The crop growth index data may be provided for an early plant stage of the specific crop, e.g. soya bean. The crop growth index data, preferably the Normalized Difference Vegetation Index (NDVI) data, may be provided for a time period, e.g. 2 weeks starting 15 days after seeding. By taking into account not only a point in time but a time period, the accuracy of the determination of which areas have been planted with which specific crop may be significantly improved.

In a step 120, an area of the geographical region cultivated with a specific crop is determined based on a comparison of the provided crop growth index data with plant-specific reference data. In an example, the crop growth index data and the reference data are NVDI data.

In a step 130, a product consumption model for the agricultural product is provided, wherein the product consumption model is configured to estimate a consumption of the agricultural product at least based on the area of the geographical region cultivated with the specific crop. For example, a consumption model for Cantus Gold, a fungicide for the treatment of ripening diseases in oilseed rape, is provided. The product consumption model may be based on the results of a machine-learning algorithm for estimating a consumption of the agricultural product. However, it is also possible to use a statistics-based product consumption model. Moreover, such a product consumption model is not limited to use the area only, i.e. further data may be used in this respect. Shelf life data of the agricultural products, expected planting decision of the farmers, pest and disease pressure data, regulatory data for the agricultural products and the like can be taken into account here in order to improve the accuracy of the product consumption estimation.

In a step 140, an estimation of the consumption of the agricultural product for the area cultivated with the specific crop is performed. For example, in case, it has been determined that in the agricultural area 1000 hectare are cultivated with oilseed rape, an estimation of the consumption of Cantus Gold can be provided.

In the following an alternative solution for estimating a consumption of an agricultural product for a geographical region is explained.

In a first step, biomass data of a specific crop, e.g. a soybean plant, with respect to the geographical region, e.g. Bavaria, for a time t₁, e.g. early crop stage, 21 days after seeding, is provided. For example, the biomass data can be derived from remote sensing measurements, e.g. satellite images or multi spectral Information, and the analysis of the of spectral reflectance values for an observed geographic area/region. The biomass data of the specific crop may be based on Normalized Difference Vegetation Index (NDVI) Data and/or Leaf Area Index (LAI) Data, Normalized Difference Water Index (NDWI), Enhanced Vegetation Index (EVI) Data and/or any other vegetation based indices data.

In a second step, a crop growth model for the specific crop configured to estimate biomass data of the specific crop for a time t₂, e.g. 6 weeks after seeding, at least based on the biomass data for the time t₁. For example, such a crop growth model may be based on the results of a machine-learning algorithm for estimating biomass data of the specific crop for the time t₂ based on the biomass data for the time t₁. Alternatively, however, it is also possible to use a statistics-based crop growth model.

In a third step, a product consumption model for the agricultural product configured to estimate a consumption of the agricultural product for the time t₂ at least based on the estimated biomass data of the specific crop for the time t₂ is provided. Also here, the product consumption model may be based on the results of a machine-learning algorithm for estimating a consumption of the agricultural product for the time t₂ and/or the time period t₁-t₂. Alternatively, however, it is also possible to use a statistics-based product consumption model. Moreover, such a product consumption model is not limited to use the biomass data only, i.e. further data may be used in this respect. For example, weather data can be taken into account, if it is not already included in the growth model. Also shelf life data of the agricultural products, expected planting decision of the farmers, pest and disease pressure data, regulatory data for the agricultural products and the like can be taken into account here in order to improve the accuracy of the product consumption estimation.

In a fourth step, an estimation of the consumption of the agricultural product for the time t₂ and/or the time period t₁-t₂ at least based on the biomass data of the specific crop for the time t₁ by using the crop growth model for the specific crop and the product consumption model for the agricultural product for the geographical region is provided.

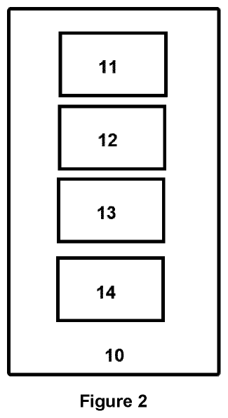

FIG. 2 is a schematic illustration of an example system 10 for estimating a consumption of an agricultural product for an area of a geographical region cultivated with a specific crop, the system 10 comprising: a providing unit 11 configured to provide crop growth index data for the geographical region; a determination unit 12 configured to determine an area of the geographical region cultivated with a specific crop at least based on a comparison of the provided crop growth index data with plant-specific reference data; a providing unit 13 configured to provide a product consumption model for the agricultural product configured to estimate a consumption of the agricultural product at least based on the area of the geographical region cultivated with the specific crop; a providing unit 14 configured to provide an estimation of the consumption of the agricultural product for the determined area of the geographical region cultivated with the specific crop at least based on the determined area cultivated with the specific crop using the product consumption model.

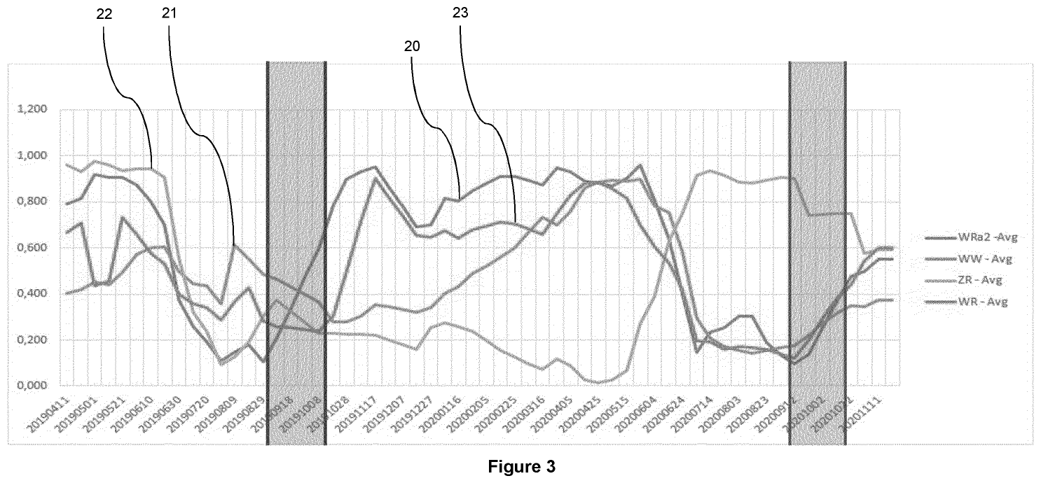

FIG. 3 is a schematic illustration of NDVI data for a geographical region over a time period between April 2019 and November 2020. The vertically highlighted areas in the NDVI data highlight the planting periods, i.e., the start of the respective season. The date is shown in the horizontal axis and the NDVI in the vertical axis. In the shown illustration, the NDVI data for winter oilseed rape (cf. WRa2; reference sign 20), winter wheat (cf. WW; reference sign 21), sugar beet (cf. ZR; reference sign 22) and winter roe (cf. WR; reference sign 23). As shown, the present disclosure allows to provide a continuous monitoring of the geographic region, so that the respective subsequent processes, e.g. manufacturing processes of the agricultural product, may also be continuously adjusted and optimized.

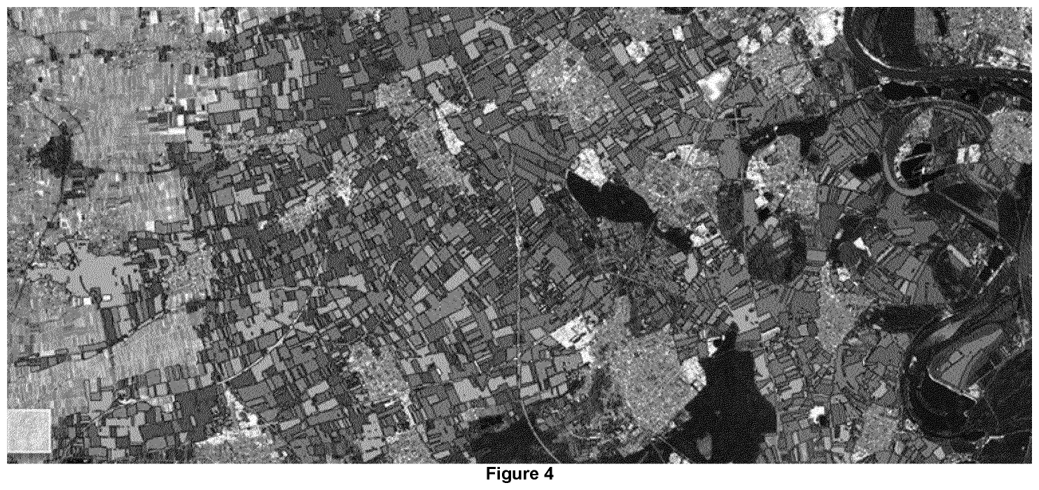

FIG. 4 shows an illustration of a geographical region in which different fields with different specific crops are highlighted as examples for better illustration. This allocation of the respective fields with a respective crop can be the result of the comparison of received NVDI data with NVDI reference data. From this, the area planted with a specific crop could subsequently be determined by adding the respective areas.

In the following, a non-exhaustive list of non-limiting examples is provided as embodiments A to R. Any one or more of the features of these examples may be combined with any one or more features of another example, embodiment, or aspect described herein.

A. A computer-implemented method for estimating a consumption of an agricultural product for a geographical region, the method comprising the steps:
providing biomass data of a specific crop with respect to the geographical region for a time t₁;
providing a crop growth model for the specific crop configured to estimate biomass data of the specific crop for a time t₂ at least based on the biomass data for the time t₁;
providing a product consumption model for the agricultural product configured to estimate a consumption of the agricultural product for the time t₂ at least based on the estimated biomass data of the specific crop for the time t₂; and
providing an estimation of the consumption of the agricultural product for the time t₂ and/or the time period t₁-t₂ at least based on the biomass data of the specific crop for the time t₁ by using the crop growth model for the specific crop and the product consumption model for the agricultural product for the geographical region.

B. Method according to embodiment A, wherein the agricultural product is a fungicide, an herbicide, an insecticide, an acaricide, a molluscicide, a nematicide, an avicide, a piscicide, a rodenticide, a repellant, a bactericide, a biocide, a safener, a plant growth regulator, a urease inhibitor, a nitrification inhibitor, a denitrification inhibitor, a fertilizer, a nutrient, a seed/seedling, and/or combination thereof.

C. Method according to embodiment A or embodiment B, wherein the biomass data of the specific crop is based on Normalized Difference Vegetation Index (NDVI) Data and/or Leaf Area Index (LAI) Data, Normalized Difference Water Index (NDWI), Enhanced Vegetation Index (EVI) Data and/or any other vegetation based indices data.

D. Method according to any one of the preceding embodiments, wherein the biomass data is obtained by using Synthetic Aperture Radar (SAR), Light Detection and Ranging (LIDAR) via satellites, unmanned vehicles, vehicle mounted sensors and/or a combination thereof.

E. Method according to any one of the preceding embodiments, wherein the time t₁ is the current time or a time between 15 and 30 days after the seeding, preferably between 17 and 25 days after seeding and most preferably 21 days after seeding, wherein t₂ is preferably between 2 and 10 weeks after t₁, preferably between 4 and 8 weeks after t₁ and most preferably 6 weeks after t₁.

F. Method according to any one of the preceding embodiments, wherein the crop growth model for the specific crop is based on the results of a machine-learning algorithm for estimating biomass data of the specific crop for the time t₂ based on the biomass data for the time t₁.

G. Method according to any one of the preceding embodiments, wherein the product consumption model is based on the results of a machine-learning algorithm for estimating a consumption of the agricultural product for the time t₂ and/or the time period t₁-t₂.

H. Method according to any one of the preceding embodiments, further comprising at least one of the following steps:
providing stock recommendation data for a minimum stock level of the agricultural product at the time t₂ based on the estimation of the consumption of the agricultural product for the time t₂ and/or the time period t₁-t₂; and/or
providing stock recommendation data for a minimum stock level of base materials necessary for the production of the agricultural product at the time t₂ based on the estimation of the consumption of the agricultural product for the time t₂ and/or the time period t₁-t₂; and/or
providing production recommendation data for producing the agricultural product based on the estimation of the consumption of the agricultural product for the time t₂ and/or the time period t₁-t₂; and/or
providing order recommendation data for ordering an amount of the agricultural product and/or an amount of base materials necessary for the production of the agricultural product based on the estimation of the consumption of the agricultural product for the time t₂ and/or the time period t₁-t₂; and/or
providing overview data for all agricultural products needed and or recommended for the specific crop for the time t₂ and/or the time period t₁-t₂; and/or
providing control data for a manufacturing process, logistics process and/or warehouse process with respect to the agricultural product based on the estimation of the consumption of the agricultural product for the time t₂ and/or the time period t₁-t₂.

I. Use of biomass data of a specific crop with respect to a geographical region in a method according to any one of embodiments A to H.

J. Computer-implemented method for providing training data for a machine learning algorithm for estimating a consumption of an agricultural product for a geographical region, comprising the steps:
providing biomass data of a specific crop with respect to the geographical region;
providing consumption data of the agricultural product for the specific crop with respect to the geographical region;
labeling the biomass data of the specific crop with the consumption data of the agricultural product for the specific crop.

K. Method according to embodiment J, wherein the biomass data and the consumption data are historical data of the geographical region comprising data of the last 3 years, preferably 5 years and most preferred 10 years.

L. Neural network/Machine learning model for estimating a consumption of an agricultural product for a geographical region trained with training data according to embodiment J or embodiment K.

M. A system for estimating a consumption of an agricultural product for a geographical region, the system comprising:
a providing unit configured to provide biomass data of a specific crop with respect to the geographical region for a time t₁;
a providing unit configured to provide a crop growth model for the specific crop configured to estimate biomass data of the specific crop for a time t₂ at least based on the biomass data for the time t₁;
a providing unit configured to provide a product consumption model for the agricultural product configured to estimate a consumption of the agricultural product for the time t₂ and/or the time period t₁-t₂ at least based on the estimated biomass data of the specific crop for the time t₂;
a providing unit configured to provide an estimation of the consumption of the agricultural product for the time t₂ and/or the time period t₁-t₂ at least based on the biomass data of the specific crop for the time t₁ by using the crop growth model for the specific crop and the product consumption model for the agricultural product.

N. Computer program element with instructions, which, when executed on computing devices of a computing environment, is configured to carry out the steps of the method according to any one of the embodiments A to H in a system according to embodiment M.

O. Computer readable medium having stored the computer program element of embodiment N.

Aspects of the present disclosure relates to computer program elements configured to carry out steps of the methods described above. The computer program element might therefore be stored on a computing unit of a computing device, which might also be part of an embodiment. This computing unit may be configured to perform or induce performing of the steps of the method described above. Moreover, it may be configured to operate the components of the above described system. The computing unit can be configured to operate automatically and/or to execute the orders of a user. The computing unit may include a data processor. A computer program may be loaded into a working memory of a data processor. The data processor may thus be equipped to carry out the method according to one of the preceding embodiments. This exemplary embodiment of the present disclosure covers both, a computer program that right from the beginning uses the present disclosure and computer program that by means of an update turns an existing program into a program that uses the present disclosure. Moreover, the computer program element might be able to provide all necessary steps to fulfill the procedure of an exemplary embodiment of the method as described above. According to a further exemplary embodiment of the present disclosure, a computer readable medium, such as a CD-ROM, USB stick, a downloadable executable or the like, is presented wherein the computer readable medium has a computer program element stored on it which computer program element is described by the preceding section. A computer program may be stored and/or distributed on a suitable medium, such as an optical storage medium or a solid state medium supplied together with or as part of other hardware, but may also be distributed in other forms, such as via the internet or other wired or wireless telecommunication systems. However, the computer program may also be presented over a network like the World Wide Web and can be downloaded into the working memory of a data processor from such a network. According to a further exemplary embodiment of the present disclosure, a medium for making a computer program element available for downloading is provided, which computer program element is arranged to perform a method according to one of the previously described embodiments of the present disclosure.

The present disclosure has been described in conjunction with a preferred embodiment as examples as well. However, other variations can be understood and effected by those persons skilled in the art and practicing the claimed invention, from the studies of the drawings, this disclosure and the claims. Notably, in particular, the any steps presented can be performed in any order, i.e. the present invention is not limited to a specific order of these steps. Moreover, it is also not required that the different steps are performed at a certain place or at one node of a distributed system, i.e. each of the steps may be performed at a different nodes using different equipment/data processing units.

In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

1. A computer-implemented method (100) for estimating a consumption of an agricultural product for an area of a geographical region cultivated with a specific crop, the method comprising:
providing (110) crop growth index data for the geographical region;
determining (120) an area of the geographical region cultivated with a specific crop at least based on a comparison of the provided crop growth index data with plant-specific reference data;
providing (130) a product consumption model for the agricultural product configured to estimate a consumption of the agricultural product at least based on the area of the geographical region cultivated with the specific crop; and
providing (140) an estimation of the consumption of the agricultural product for the determined area of the geographical region cultivated with the specific crop for the geographical region at least based on the determined area cultivated with the specific crop using the product consumption model.

2. The computer-implemented method according to claim 1, wherein the agricultural product is a fungicide, an herbicide, an insecticide, an acaricide, a molluscicide, a nematicide, an avicide, a piscicide, a rodenticide, a repellant, a bactericide, a biocide, a safener, a plant growth regulator, a urease inhibitor, a nitrification inhibitor, a denitrification inhibitor, a fertilizer, a nutrient, a seed/seedling, and/or combination thereof.

3. The computer-implemented method according to claim 1, wherein the crop growth index data is Normalized Difference Vegetation Index (NDVI) data, Leaf Area Index (LAI) data, Normalized Difference Water Index (NDWI) data, Enhanced Vegetation Index (EVI) data.

4. The computer-implemented method according to claim 1, wherein cultivated areas in the geographical region are determined for a preselected group of crops based on the crop growth index data for the geographical region.

5. The computer-implemented method according to claim 1, wherein the crop growth index data are provided at an early crop stage of the specific crop.

6. The computer-implemented method according to claim 1, wherein the crop growth index data are provided for a time period between a starting time t₁ which is the current time or a time between 15 and 30 days after the seeding of the specific crop and an ending time t₂ which is between 2 and 10 weeks after t₁.

7. The computer-implemented method according to claim 1, wherein the crop growth index data are provided for a predetermined time series.

8. The computer-implemented method according to claim 1, wherein the plant-specific reference data are provided by a central and/or distributed computing environment.

9. The computer-implemented method according to claim 1, wherein determining the area cultivated with the specific crop is based on data obtained by using Synthetic Aperture Radar (SAR), Light Detection and Ranging (LIDAR) via satellites, unmanned vehicles, vehicle mounted sensors and/or a combination thereof.

10. The computer-implemented method according to claim 1, wherein the product consumption model for the area cultivated with the specific crop is based on the results of a machine-learning algorithm configured to estimate the consumption of the agricultural product at least based on the area of the geographical region cultivated with the specific crop.

11. The computer-implemented method according to claim 1 any of the, further comprising
providing stock recommendation data for a minimum stock level of the agricultural product at a specific time and/or for a time period based on the estimation of the consumption of the agricultural product; and/or
providing stock recommendation data for a minimum stock level of base materials necessary for the production of the agricultural product at a specific time and/or for a time period based on the estimation of the consumption of the agricultural product; and/or
providing production recommendation data for producing the agricultural product based on the estimation of the consumption of the agricultural product; and/or
providing order recommendation data for ordering an amount of the agricultural product and/or an amount of base materials necessary for the production of the agricultural product based on the estimation of the consumption of the agricultural product; and/or
providing overview data for agricultural products needed and/or recommended for the specific crop; and/or
providing control data for a manufacturing process, logistics process and/or warehouse process with respect to the agricultural product based on the estimation of the consumption of the agricultural product.

12. A computer-implemented method for providing training data for a machine learning algorithm for estimating a consumption of an agricultural product for an area of a geographical region cultivated with a specific crop, the method comprising:
providing data comprising information about an area cultivated with a specific crop;
providing consumption data of the agricultural product for the provided area cultivated with the specific crop; and
labeling the data comprising information about the area cultivated with the specific crop with the consumption data of the agricultural product for the provided area cultivated with the specific crop.

13. A neural network/Machine learning model for estimating a consumption of an agricultural product for an area of a geographical region cultivated with a specific crop trained with training data according to the method of claim 12.

14. An apparatus for estimating a consumption of an agricultural product for an area of a geographical region cultivated with a specific crop, the apparatus comprising:
one or more computing nodes and one or more computer-readable media having thereon computer-executable instructions that are structured such that, when executed by the one or more computing nodes, cause the apparatus to perform the following steps:
providing (110) crop growth index data for the geographical region;
determining (120) an area of the geographical region cultivated with a specific crop at least based on a comparison of the provided crop growth index data with plant-specific reference data;
providing (130) a product consumption model for the agricultural product configured to estimate a consumption of the agricultural product at least based on the area of the geographical region cultivated with the specific crop; and
providing (140) an estimation of the consumption of the agricultural product for the determined area of the geographical region cultivated with the specific crop at least based on the determined area cultivated with the specific crop using the product consumption model.

15. A non-transitory computer readable medium having instructions encoded thereon which, when executed on one or more computing node(s), cause the one or more computing node(s) to carry out the steps of the method of claim 1.
